(19) United States
(12) Patent Application Publication
(10) Pub. No.: US 2025/0116555 A1
(43) Pub. Date: Apr. 10, 2025

(54) ENHANCED IMAGE PROCESSING FOR THERMAL IMAGERS

(71) Applicant: RPX Technologies, Inc., Stillwater, OK (US)

(72) Inventors: Michael J. Fox, Stillwater, OK (US); Craig A. Aker, Stillwater, OK (US)

(21) Appl. No.: 18/909,678

(22) Filed: Oct. 8, 2024

Related U.S. Application Data
(60) Provisional application No. 63/588,908, filed on Oct. 9, 2023.

(51) Int. Cl. G01J 5/24; G01J 5/00; G06T 5/90; H04N 23/23

(52) U.S. Cl. CPC G01J 5/24; G06T 5/90; H04N 23/23; G01J 2005/0077; G06T 2207/10048

(57) ABSTRACT

Systems and methods are described herein including a system, comprising a thermal camera, a processor and a non-transitory processor-readable medium. The thermal camera comprises one or more thermal image sensor operable to convert infrared radiation into a thermal image. The thermal image having pixels in an array of numerical pixel values having i rows and j columns. The non-transitory processor-readable medium stores processor-executable instructions that when executed by the processor cause the processor to: determine a dynamic range of the thermal image; and apply a kernel to numerical pixel values of the array to produce an enhanced thermal image, the kernel having a strength factor based at least in part on the dynamic range of the thermal image.

### REFERENCE TO RELATED APPLICATION

The present patent application claims priority to the provisional patent application identified by U.S. Ser. No. 63/588,908, filed on Oct. 9, 2023, the entire content of which is hereby incorporated herein by reference.

### BACKGROUND ART

Infrared cameras having infrared image sensors capture thermal images of thermal energy radiation emitted by objects having a temperature above absolute zero. Such cameras may be used to produce thermal images (e.g., thermograms) that may be used in a variety of applications, such as viewing in low light or no light conditions, identifying anomalies in human body temperature (e.g., for detecting illnesses), detecting imperceptible gases, assessing structures for water leaks and insulation damage, identifying unseen damage in electrical and mechanical equipment, and various other applications.

However, infrared cameras, particularly those based on microbolometer technology within the Long Wavelength Infrared (LWIR) spectrum, often produce thermal images exhibiting lower resolution when compared to images produced by Electro-Optical (EO) cameras. This lower resolution is primarily due to larger pixel sizes, which are typically limited to around 10 μM due to LWIR wavelengths, and the complexities associated with manufacturing infrared image sensors based on microbolometer technology. Furthermore, thermal images produced by microbolometers often display fixed pattern noise, such as row, column, and other patterned noise. While thermal images may benefit from conventional image enhancement techniques, such conventional image enhancement techniques may inadvertently accentuate the fixed pattern noise, thereby degrading the quality of the thermal images rather than improving the quality.

### SUMMARY OF THE INVENTION

The deficiencies of the prior art are addressed by systems and methods described herein. The problem of inadvertently accentuating the fixed pattern noise, thereby degrading the quality of the thermal images is addressed by measuring a dynamic range or noise within the thermal image, and then applying a kernel to numerical pixel values of the array to produce an enhanced thermal image. The kernel has a strength factor based on the dynamic range and/or noise of the thermal image.

In some embodiments, the present disclosure describes a system, comprising a thermal camera, a processor and a non-transitory processor-readable medium. The thermal camera comprises one or more thermal image sensor operable to convert infrared radiation into a thermal image. The thermal image has pixels in an array of numerical pixel values having i rows and j columns. The non-transitory processor-readable medium stores processor-executable instructions that when executed by the processor cause the processor to: determine a dynamic range of the thermal image; and apply a kernel to numerical pixel values of the array to produce an enhanced thermal image, the kernel having a strength factor based at least in part on the dynamic range of the thermal image.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an exemplary embodiment of an unmanned vehicle constructed in accordance with the present disclosure;

FIG. 2 is a front perspective view of another exemplary embodiment of the unmanned vehicle shown in FIG. 1 constructed in accordance with the present disclosure;

FIG. 3 is side perspective view of an exemplary embodiment of a camera system shown in FIGS. 1 and 2 constructed in accordance with the present disclosure;

FIG. 4 is a diagrammatic view of another exemplary embodiment of the camera system shown in FIGS. 1-3 constructed in accordance with the present disclosure;

FIG. 5 is a process flow diagram of a method of enhancing thermal images captured by a microbolometer based infrared image sensor without accentuating fixed pattern noise in accordance with the present disclosure;

FIG. 6A is a diagrammatic view of an exemplary embodiment of a thermal image constructed in accordance with the present disclosure;

FIG. 6B is a diagrammatic view of an exemplary embodiment of an upscaled thermal image constructed in accordance with the present disclosure; and

FIG. 6C is a diagrammatic view of an exemplary embodiment of a kernel constructed in accordance with the present disclosure being applied to the upscaled thermal image shown in FIG. 6B.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, a “kernel” (or “convolution matrix” or “mask”) is a small matrix or window of pixels used for blurring, sharpening, detecting edges, and performing other image processing functions by means of convolution. In use, the kernel is applied to each pixel of an input image, the kernel's values are multiplied with the corresponding pixel values in the input image, and then the results are summed. The size of a kernel refers to the dimensions of the matrix or window. For example, a i×j kernel has i rows and j columns.

As used herein, “dynamic range” refers to a measurement of a difference between a brightest pixel (i.e., a pixel with a highest intensity) and a darkest pixel (i.e., a pixel with a lowest intensity) in the thermal image. A higher dynamic range indicates that the thermal image contains more detail in the highlights and/or shadows of the image, resulting in a more complete representation of the environment and/or subject depicted in the thermal image. The dynamic range may be measured either as a ratio or as a base-10 (i.e., decibels) or base-2 (i.e., doublings, bits, or stops) logarithmic scales. The dynamic range DNR of an image may be quantified using the formula:

$$DNR = 20 log \frac{Highest pixel value}{Lowest pixel value}$$

where the highest pixel value is the intensity of the brightest pixel and the lowest pixel value is the intensity of the darkest pixel. The dynamic range may also be quantified by subtracting the lowest pixel value from the highest pixel value or by determining the standard deviation of the pixel values in which case the dynamic range is referred to as a “span” and is measured in “counts”.

The presently disclosed inventive concepts include a method of enhancing a thermal image captured by a microbolometer-based infrared image sensor of a thermal camera. Such method generally involves applying a kernel to pixels (e.g., each pixel) of a thermal image to enhance a contrast of the thermal image, wherein the kernel has a strength factor applied thereto based on a dynamic range (or span) of the thermal image. Additionally, the presently disclosed inventive concepts include a method of enhancing the thermal image at a sub-pixel level by upscaling the thermal image (e.g., by copying or interpolating pixels) prior to applying the kernel.

More particularly, the presently disclosed inventive concepts may include applying a n×n kernel to the thermal image that operates on each pixel column and each pixel row of the thermal image simultaneously to enhance a contrast of a center pixel. Further, a strength of the enhancement may be dynamically adjusted by applying the strength factor to the kernel before applying the kernel to the thermal image. The strength factor may be dynamically adjusted such that: (1) for thermal images with a relatively low span or dynamic range (and, therefore, a low signal-to-noise ratio (SNR)), the strength factor may be reduced to zero, thereby ensuring that the enhancement does not amplify noise and degrade the thermal image; and (2) for thermal images with a relatively high span or dynamic range (and, therefore, a high SNR), the strength factor may be increased to accentuate details in the thermal images which are likely not dominated by noise.

In some embodiments, applying a 3×3 kernel K to an input image/includes performing a convolution operation on at least some of the pixels (i, j) (e.g., each pixel). For each input pixel (i, j) of the input image/upon which the convolution operation is performed, the intensity of the output pixel (i, j) of the output image l′ is given by:

$${I}^{′} ( i , j ) = {\sum }_{m = - 1}^{1} {\sum }_{n = - 1}^{1} I ( i + m , j + n ) * K ( m + 1 , n + 1 )$$

where I(i, j) is the intensity of the pixel (i, j) of the input image I, I′(i, j) is the intensity of the pixel (i, j) of the output image l′, and K (u+1, v+1) is the value of the kernel K at position (u+1, v+1). The double summation thus iterates over the 3×3 region around the pixel (i, j) of the input image I.

While many variations of conventional sharpening kernels may assist in sharpening certain images, particular variations of conventional sharpening kernels may apply less enhancement to noise that perfectly aligns with rows and columns of the input image, effectively mitigating much of the fixed-pattern noise originating from imaging sensors, thereby improving image quality compared to other kernels that may incorporate influence from diagonal components. One example of this type of conventional sharpening kernel is given by:

$$K = [ \begin{matrix}0 & - 1 & 0 \\ - 1 & 5 & - 1 \\ 0 & - 1 & 0\end{matrix} ]$$

The presently disclosed inventive concepts include use of a variable strength sharpening kernel, wherein the strength of the sharpening kernel is based on a dynamic range of an image. The basic form of an exemplary 3×3 variable strength sharpening kernel is given by:

$$K = [ \begin{matrix}0 & 0 & 0 \\ 0 & 1 & 0 \\ 0 & 0 & 0\end{matrix} ] + [ \begin{matrix}0 & - 1 & 0 \\ - 1 & 4 & - 1 \\ 0 & - 1 & 0\end{matrix} ] * S$$

where S is a strength factor based on the dynamic range of the image. The strength factor S may be given by:

$$S = max ( ( span - lower threshold ) * scaling factor , 0 )$$

where lower threshold is a predetermined lower threshold (e.g., 300 counts) and scaling factor is a predetermined scaling factor (e.g., 0.002).

Particular exemplary embodiments of the 3×3 variable strength sharpening kernel may be given by:

$$[ \begin{matrix}0 & 0 & 0 \\ 0 & 1 & 0 \\ 0 & 0 & 0\end{matrix} ] \qquad a )$$

$$[ \begin{matrix}0 & - 0.5 & 0 \\ - 0.5 & 3 & - 0.5 \\ 0 & - 0.5 & 0\end{matrix} ] \qquad b )$$

$$[ \begin{matrix}0 & - 1 & 0 \\ - 1 & 5 & - 1 \\ 0 & - 1 & 0\end{matrix} ] \qquad c )$$

$$[ \begin{matrix}0 & - 2 & 0 \\ - 2 & 9 & - 2 \\ 0 & - 2 & 0\end{matrix} ] \qquad d )$$

where a) is unsharpened, b) is a relatively weak sharpening, c) is a traditional sharpening filter (i.e., amplitude=1), and d) is a relatively strong sharpening.

As referenced above, the strength of the sharpening kernel is based on the dynamic range of the image. Accordingly, a kernel applied to an image with a span of 300 counts would have a lower strength factor than a kernel applied to an image with a span of 2,000 counts. However, in some instances, extreme pixel values (i.e., the highest and lowest pixel values) of an image may negatively affect the sharpening operation. In some instances, the extreme pixel values (such as the brightest highlights and the darkest shadows) may be outlier pixel values that do not contribute to the image's overall structure or detail, or may be more prone to noise. Therefore, in some instances, before the strength factor is determined and the sharpening kernel is applied, one or more extreme pixel value (e.g., the top and bottom 2% of pixel values) may be removed from the image to improve the sharpening operation.

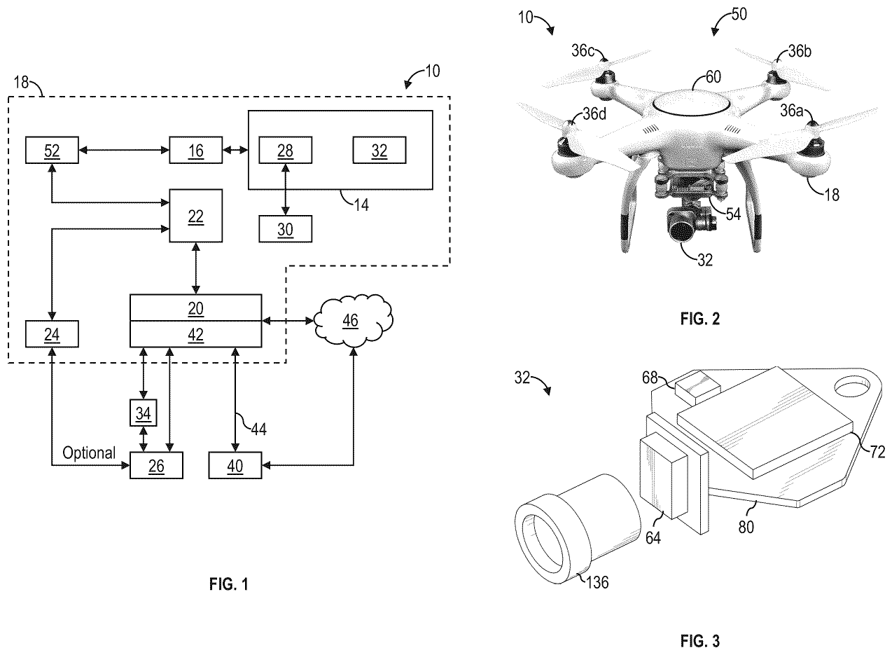

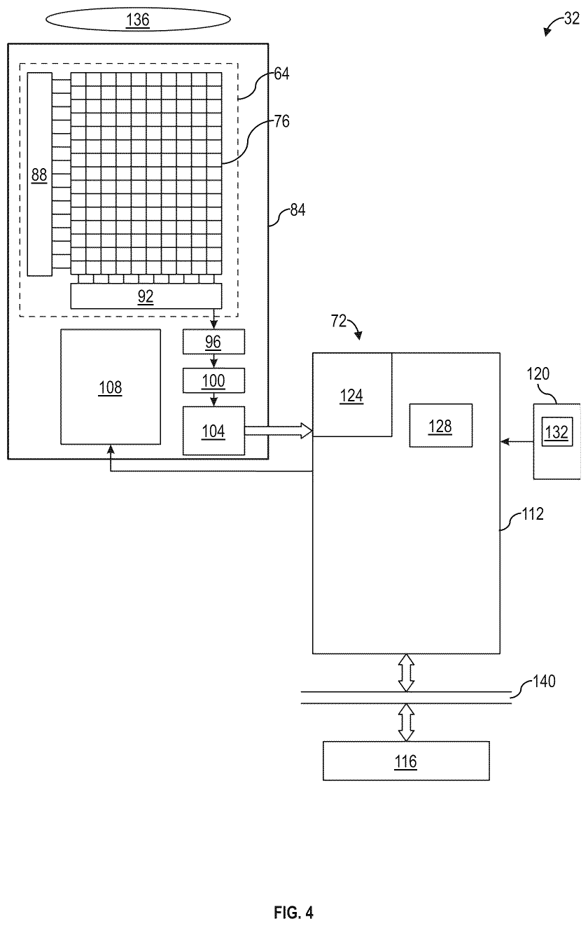

Referring now to the drawings and in particular to FIGS. 1 and 2, shown therein is an exemplary embodiment of an unmanned vehicle 10 (hereinafter the “vehicle 10”). The vehicle 10 is shown in FIGS. 1 and 2 as being an unmanned aerial vehicle (UAV); however, in other embodiments, the vehicle 10 may be an unmanned ground vehicle (UGV). The vehicle 10 may follow a navigation path above, within, and/or about a subject such as a tree, building, person, animal, and/or the like at a distance while avoiding obstacles such as a tower, antenna, wire, and/or the like. The vehicle 10 may be directed into burning houses to determine whether or not any people or animals are in need of rescue, for example. The vehicle 10 may be configured to output 2D visible images, infrared images, or three dimensional or two-dimensional files (e.g., CAD files) of the subject for identification, operator monitoring, and/or other purposes.

In some embodiments, the vehicle 10 may comprise a medium source 14, a collision detection and avoidance system (CDAS) 16, an aerial platform 18, an onboard data processing and transmission system 20, a control system 22, and a piloting system 24. Using the piloting system 24, a user 26 may pilot the aerial platform 18 via virtual reality, augmented reality, smartphone (e.g., iPhone), tablet, joystick, remote control system, and/or the like. In some embodiments, the vehicle 10 may be piloted autonomously (i.e., direction by the user 26 may be optional). One or more camera 32 (e.g., stereoscopic camera, standard camera, 360-degree camera, combinations thereof, or the like) on the aerial platform 18 may present one or more views of the environment to the user 26. For example, the user 26 may be provided one or more views of an environment for positioning and/or moving the aerial platform 18 around the subject. The virtual or augmented reality may allow for the user 26 to observe the subject and/or the environment from the point of view of the aerial platform 18, as if the user 26 is on the aerial platform 18. Additionally, virtual or augmented reality may provide the user 26 with additional information about flight and/or operating status of the aerial platform 18. In some embodiments, the user 26 may utilize a radio-frequency control module configured to transmit commands to the aerial platform 18 during flight of the aerial platform 18. The nature of the commands may depend on flying and/or propulsion mechanism in use by the aerial platform 18, including, but not limited to, jet propulsion (not shown), a fixed wing with one or more propellers (not shown), or non-fixed wing with a plurality of rotors 36 (hereinafter the “rotors 36”), shown in FIG. 2 as a first rotor 36a, a second rotor 36b, a third rotor 36c, and a fourth rotor 36d. While the aerial platform 18 is shown in FIG. 2 as having four of the rotors 36, it should be understood that the aerial platform 18 may have more or less than four of the rotors 36.

Once the aerial platform 18 is in flight, the medium source 14 may be used to emit a medium to assist in piloting the aerial platform and/or illuminating the subject. The medium source 14 may include an optical source 28 capable of projecting electromagnetic energy (e.g., visible light) onto the subject. The medium source 14 may use other types of mediums, such as sound, thermal energy, and/or the like. A camera system 32 may record data of the illumination on the subject or thermal energy radiation emitted by the subject. In some embodiments, the mounting of the optical source 28 and the camera system 32 on the aerial platform 18 may provide the rigidity to ensure that the optical source 28 and the camera system 32 remain in the same geometrical relationship (i.e., static geometrical relationship) with each other without significant movement during and/or between recording events. In some embodiments, such mounting may be lightweight to avoid consuming payload capacity of the aerial platform 18.

The data obtained from the camera system 32 may be used to locate the subject and direct the piloting system 24. In some embodiments, the distance between the optical source 28 and the camera system 32 and/or the angular orientation of the optical source 28 and the camera system 32 may be fixed or dynamic. In some embodiments, the optical source 28 may illuminate the subject in a strobed fashion, or with a series of different optical patterns.

In some embodiments, an optional external optical source 34 may provide additional medium(s) aimed at the subject. An exemplary external optical source 34 may be a flashlight operated by a police officer. Such scans may provide data on the environment surrounding the subject, to assist in aiming the optical source 28 at the subject. For example, the control system 22 may be programmed to determine the location of where the additional medium is pointing by using information obtained from the camera system 32, and provide control instructions to the piloting system 24. The information from the external optical source 34 may also be used to avoid collisions with the subject and/or interfering objects that may damage, incapacitate, and/or destroy the aerial platform 18.

The control system 22 may generally coordinate the operation of the medium source 14, the CDAS 16, the onboard data processing and transmission system 20, and the distance sensor 25. The control system 22 may obtain input from the CDAS 16 and either alert the user 26 when the aerial platform 18 may be at a pre-determined distance to the subject or interfering object, thus allowing the user 26 to decide appropriate action. In some embodiments, the control system 22 may signal the aerial platform 18 to take rapid evasive action independent of the user 26.

In some embodiments, the onboard data processing and transmission system 20 may perform initial electronic processing in preparation for transmission to a collection station 40. Such processing may include, but is not limited to, data compression, preliminary registration (e.g., compensation for movement of the aerial platform 18 between captures), encapsulation of data in a format used by a transmission link, image sharpening as described herein, and/or the like.

In some embodiments, a transmitter 42 (e.g., RF transmitter) of the onboard data processing and transmission system 20 may transmit the processed data to the collection station 40. For example, the transmitter 42 may transmit the processed data to the collection station via a network 44 and/or a cloud service 46. Such network 44 may be implemented as the World Wide Web (or Internet), a local area network (LAN), a wide area network (WAN), a metropolitan network, a wireless network, a cellular network, a Global System for Mobile Communications (GSM) network, a code division multiple access (CDMS) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

Location of the collection station 40 may include, but is not limited to, a vehicle, building, other stationary object, or a second aerial vehicle (e.g., airplane). Within the collection station 40, or within a second location in communication with the collection station 40, a receiver may collect and/or retrieve the processed data sent by the transmitter 42.

The optical source 28 may be any light emitting device such as one or more LED, or laser(s).

The control system 22 may use any computational algorithm existing for identification of objects of interest in images collected by the camera system 32 and such computation algorithm may be stored in one or more non-transitory computer readable medium. Generally, the control system 22 may include one or more processor coupled with the one or more non-transitory processor readable medium, and configured to automatically execute this methodology to identify and/or obtain information about objects of interest for a variety of purposes.

The control system 22 may include one or more processor. The term “processor” will include multiple processors unless the term “processor” is limited by a singular term, such as “only one processor”. In some embodiments, the processor may be partially or completely network-based or cloud-based. The processor may or may not be located in a single physical location. Additionally, multiple processors may or may not be necessarily be located in a single physical location.

The processor may include, but is not limited to, implementation as a variety of different types of systems, such as a digital signal processor (DSP), a central processing unit (CPU), a field programmable gate array (FPGA), a microprocessor, a multi-core processor, a quantum processor, application-specific integrated circuit (ASIC), a graphics processing unit (GPU), a visual processing unit (VPU), combinations thereof, and/or the like.

The processor may be capable of reading and/or executing executable code stored in the one or more non-transitory processor readable medium and/or of creating, manipulating, altering, and/or storing computer data structures into the one or more non-transitory processor readable medium. The one or more non-transitory processor readable medium may be implemented as any type of memory, such as random-access memory (RAM), a CD-ROM, a hard drive, a solid-state drive, a flash drive, a memory card, a DVD-ROM, a floppy disk, an optical drive, and combinations thereof, for example. The non-transitory readable medium may be located in the same physical location as the processor, or located remotely from the processor and may communicate via a network. The physical location of the one or more non-transitory processor readable medium may be varied, and may be implemented as a “cloud memory” (i.e., one or more non-transitory processor readable medium may be partially or completely based on or accessed via a network).

In some embodiments, the control system 22 may be configured to receive additional data from one or more external sources. In some embodiments, the external source may be data input by the user 26. In some embodiments, the external source may be data associated with a third-party system (e.g., weather, GPS satellite). The information may be provided via a network or input device, including, but not limited to, a keyboard, touchscreen, mouse, trackball, microphone, fingerprint reader, infrared port, slide-out keyboard, flip-out keyboard, call phone, PDA, video game controller, remote control, fax machine, network interface, speech recognition, gesture recognition, eye tracking, brain-computer interface, combinations thereof, and/or the like.

In some embodiments, prior to movement of the aerial platform 18, the user 26 may provide the control system 22 with some or all parameters to aid the CDAS 16 in navigation. Parameters may include, but are not limited to, information identifying the subject, suggested flight path, estimated height of subject, and/or the like. The CDAS 16 may include AI software configured to navigate the aerial platform 18 based on parameters, received data from environment mapping, extracted data from scanning data processed onboard or provided via network from the user 26, and/or the like.

The aerial platform 18 may be configured to support and move the medium source 14, CDAS 16, onboard processing and transmission system 20, control system 22, and piloting system 24 within the air. In some embodiments, the aerial platform 18 may be configured to move at a predetermined low speed (e.g., 1 km/h). Additionally, the aerial platform 18 may be configured to hover (i.e., remain stationary) within the air. For example, the aerial platform 18 may be configured to move at a low speed or hover as the optical source 28 is aimed at the subject, or the camera system 32 obtains sensor data of the subject. The aerial platform 18 may also include load capacity permitting unimpeded aerial navigation while transporting the medium source 14 and the CDAS 16. Further, the aerial platform 18 may be configured to carry fuel to sustain long periods of flight (e.g., 2 hours) prior to refueling.

Generally, the aerial platform 18 may include one or more mechanical platform 50 (hereinafter the “mechanical platform 50”), one or more propulsion system 52 (hereinafter the “propulsion system 52”), and one or more mounting system 54 (hereinafter the “mounting system 54”). The piloting system 24 may aid in providing direction to the propulsion system 52 or the mounting system 54. In some embodiments, the mounting system 54 may be connected between the camera system 32 and the mechanical platform 50 such that the mechanical platform 50 supports the camera system 32. In some embodiments, the mounting system 54 may include a gimbal for moving the camera system 32 relative to the mechanical platform 50.

In some embodiments, the propulsion system 52 may include two or more rotors 36 (e.g., helicopter, quadcopter, octocopter), such as a drone. In some embodiments, the four or more rotors 36 may be attached to electric motors for rotating the rotors 36. In some embodiments, relative rotational velocity of the four or more rotors 36 may be configured to control direction and/or speed of flight of the aerial platform 18. By controlling the relative rotational velocity of the four or more rotors 36, the aerial platform 18 may obtain slow and/or stationary flight (i.e., hovering), and may operate for extended periods of time. The aerial platform 18 may include other configurations of the propulsion system 52 configured to utilize different placement and/or propulsion providing slow and/or stationary flight.

In some embodiments, the aerial platform 18 may include one or more power source (not shown). The power source may include one or more supplies of power to at least one or more electric loads on the aerial platform 18. The power source may include, but is not limited to electrical, solar, mechanical, or chemical energy. For example, in some embodiments, fuel may be used to power one or more component of the aerial platform 18. Additionally, one or more battery may be included as one or more power source for the aerial platform 18.

In some embodiments, a diameter of the medium generated by the medium source 14 may be automatically adjusted to a minimum effective size relative to the size which is proportionate to the size of at least a part of the subject.

High-temperature survivability is a critical capability when using unmanned vehicles in certain situations such as fire-fighting. However, the construction of most previous vehicles, such as unmanned aerial vehicles, is not ideal for such high-temperature environments. To improve the survivability of these vehicles, several inventive approaches may be taken as described below.

First, the mechanical platform 50 may include a housing 60 surrounding electronics and other components forming the CDAS 16, the transmission system 20, the control system 22, the piloting system 24, and the transmitter 42. Components of these systems which should be exposed to the environment around the housing, such as certain types of sensors, may be provided through an opening in the housing 60. As explained in more detail below, the vehicle 10 may include a temperature buffer around the electronics. The temperature buffer is configured to protect the electronics from temperatures outside of the housing 60 above maximum thermal operating characteristics of the electronics. The temperature buffer may be constructed of a material configured to reflect electromagnetic wavelengths in a range of 500 nm to 2 μm, an insulating material, a cooling material, a phase change material (PCM), combinations thereof, and/or the like.

In use, the vehicle 10 may be exposed to fire and subjected to significant radiative heat transfer. The radiative heat transfer may be minimized by covering the vehicle's components, including the housing 60 with IR-reflective materials that reflect wavelengths in the 500 nm to 2 μm range. One applicable covering or construction material is aluminum. This material may be applied directly to the underlying structure, such as the housing 60, or may be stood off slightly to act as a radiative heat shield.

A second approach to reducing temperature rise in the vehicle 10 is to incorporate PCMs into the construction of the vehicle 10. Initially, solid-liquid PCMs behave like sensible heat storage (SHS) materials. The temperature of the PCM rises as the PCM absorbs heat. When PCMs reach the temperature at which they change phase (the PCM's melting temperature), the PCM absorbs large amounts of heat and remains at an almost constant temperature. The PCM continues to absorb heat without a significant rise in temperature until all the PCM is transformed to the liquid phase. Long chain paraffin wax is one such material that changes phase at moderate temperatures and could be used to absorb heat. Another alternative is water. Liquid water stored in the mechanical platform 50 must be boiled before the surrounding structure temperature may rise above 100° C. which is still cool enough to protect most electronics, including integrated circuitry. Thus, temperature sensitive components of the vehicle 10, such as electronics within the CDAS 16, the transmission system 20, the control system 22, the piloting system 24, the transmitter 42, and any motor(s) driving the rotors 36 may be surrounded by a container containing the PCM. Ice is another example of a PCM in which the ice transforming from solid to liquid is an option. Further, another material, such as chilled water or an antifreeze liquid may be passed across the ice and throughout sensitive components of the vehicle 10. The container may be designed to have an inlet or outlet, so that the PCM may be removeable and replaced with fresh PCM. In some embodiments, this may be accomplished by implementing the container holding the PCM as a replaceable cartridge. The time it takes to transform all of the PCM adds to a safe operating time that the vehicle 10 may be exposed to extreme heat. Once all of the PCM material has changed phase, it must be “regenerated” by waiting for the PCM to cool. Alternately onboard water could be sprayed onto sensitive components for cooling or atomized water could be delivered to external vehicle components to take advantage of evaporative cooling. Water may also be stored in the vehicle in a frozen state which then requires a great deal of energy absorption to transition the material through two phase changes prior to the protected structures exceeding 100° C.

Sensitive components may also be insulated with a suitable insulating material, such as an aerogel which offers tremendous insulating properties with minimal weight. Aerogel typically has a density between 0.0011 to 0.5 g/cm³, with a typical average of around 0.020 g/cm³. This means that aerogel is usually only 15 times heavier than air, and has been produced at a density of only 3 times that of air. A typical silica aerogel has a total thermal conductivity of ˜0.017 W/mK. Temperature sensitive components of the vehicle 10, such as electronics within the CDAS 16, the transmission system 20, the control system 22, the piloting system 24, the transmitter 42, and any motor(s) driving the rotors 36 (especially those that generate little heat) may survive longer in hot environments when protected with such materials.

The temperature of the rotors 36, being thin and lightweight, is also considered when maximizing vehicle operating longevity at high temperatures. Unmitigated, the rotor temperature will quickly reach ambient temperatures due to the thin, lightweight structure and enhanced convective heat transfer resulting from the rotor's velocity through the air. The rotors 36 may be constructed from heat resistant materials such as graphene, graphite, or carbon nanotubes (e.g., MIRALON® manufactured by Huntsman Corporation). Another approach to cooling the rotor 36 is by pumping a cool or liquid phase changing material through one or more blade(s) of the rotors 36 in flight. In some embodiments, may can be accomplished by passing cooled air (e.g. air passed across the PCM) through passages in the rotors 36.

The camera system 32, such as a thermal camera and other electronics, may also be sensitive to heat. In this case, heat levels elevated above an operating temperature range of the camera system 32 affects the optical sensor's ability to function and generate high-quality images. These components may be cooled with a liquid or gas. For example, these components may be cooled with water from an onboard ice bath which increases the performance of the camera system 32. The camera system 32 may be configured to detect and form images of energy in a Long Wavelength Infrared (LWIR) band of the electromagnetic spectrum having a wavelength between 6 μm and 14 μm. The camera system 32 may be cooled by the PCM, such as water. Printed circuit boards and their associated components may be cooled by a similar means. Internal cavities may be used to carry cooled liquid inside the printed circuit board thereby cooling the board and key components. In some embodiments, the vehicle 10 may include an atomizer (not shown) on the mechanical platform 50, and a fluid delivery system (not shown) connected to the atomizer and configured to supply a fluid to the atomizer, whereby atomized fluid may be released outside of the mechanical platform 50 during flight of the aerial platform 18 to create a cooler operating environment.

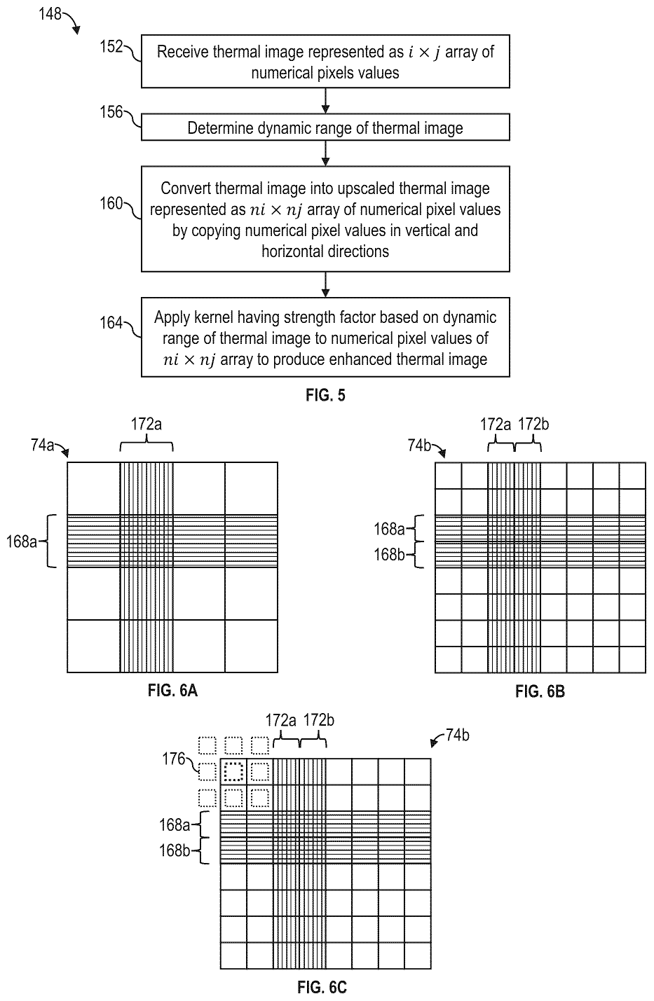

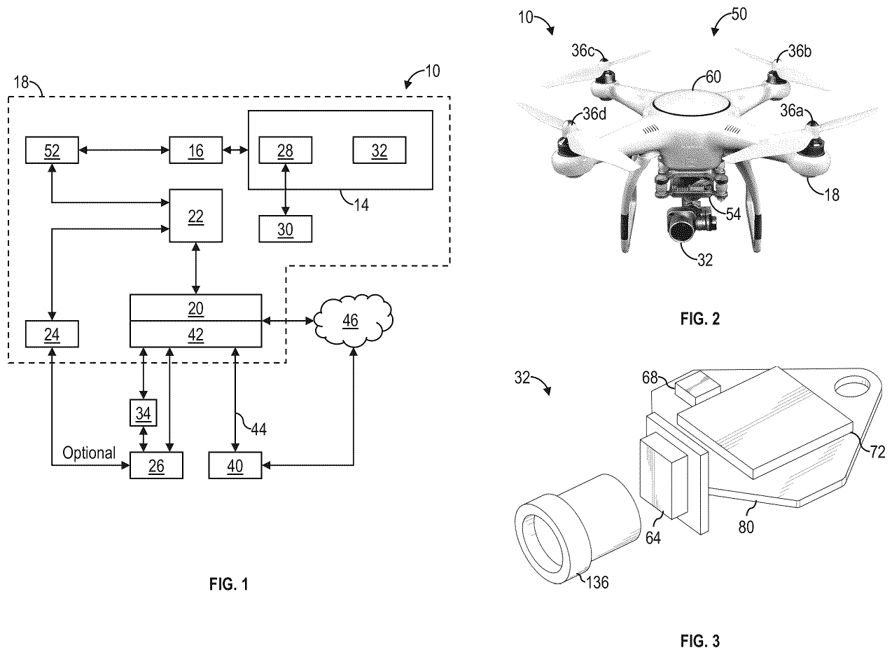

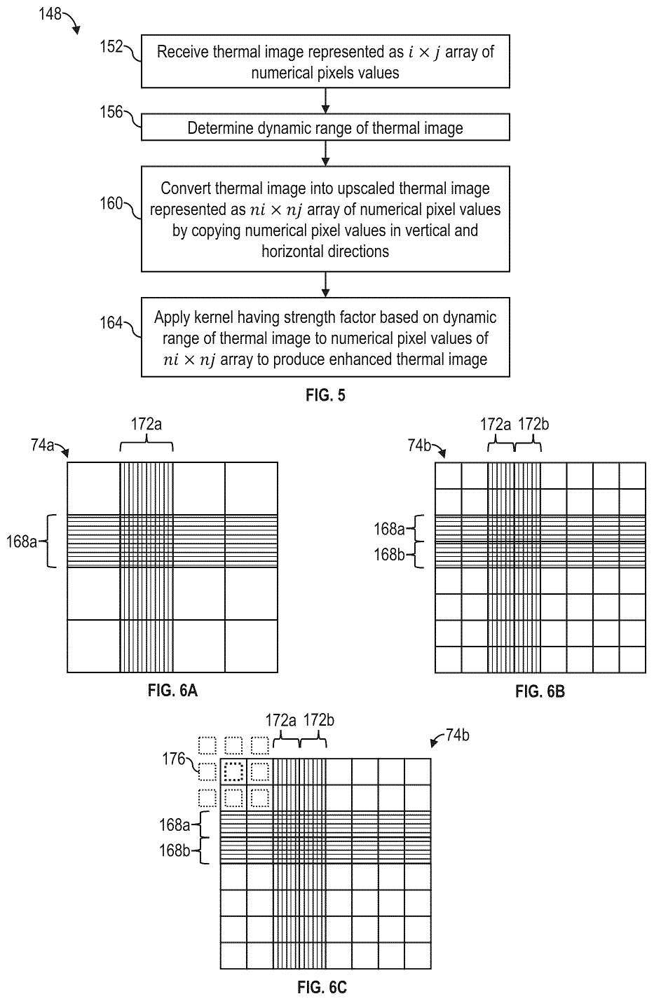

Referring now to FIG. 3, shown therein is a side perspective view of an exemplary embodiment of the camera system 32 constructed in accordance with the present disclosure. As shown in FIG. 3, the camera system 32 may comprise a focal plane array 64, a motion sensor 68, and a processor 72. The focal plane array 64 may have a two-dimensional array of pixels 76 (e.g., plurality of adjacently disposed sensors) (shown in FIG. 4) sensing images 74 (shown in FIGS. 6A-6C as a thermal image 74a and an upscaled thermal image 74b, by way of example) on a per-pixel basis at a first frame rate. Each of the pixels 76 may include an optical sensor (not shown) to sense light within a particular range of wavelengths. For example, the optical sensors may be configured to detect visible light, or other wavelengths, such as a Near Infrared (NIR), Short Wavelength Infrared (SWIR), Medium Wavelength Infrared (MWIR), LWIR, or Ultraviolet (UV) band. The term “infrared” as used herein refers to a portion of the electromagnetic spectrum having wavelengths between 800 nm and 20 μm.

The pixels 76 have a known angular resolution (e.g., on a milli-radian basis) between pixels. The focal plane array 64 may be configured to convert electromagnetic information into image pixel data at multiple distinct instants of time during an image capture period. The motion sensor 68 may be rigidly connected to the focal plane array 64 such that movement of the focal plane array 64 matches movement of the motion sensor 68. For example, the focal plane array 64 and the motion sensor 68 may be rigidly mounted on a mechanical support mechanism 80. The mechanical support mechanism 80 may have sufficient mechanical strength so that the focal plane array 64 moves with the motion sensor 68. The mechanical support mechanism 80 may have a structure of sufficient rigidity to provide accurate motion sensing to less than the angle of the pixel FOV. The mechanical support mechanism 80 may be connected to the vehicle 10.

The motion sensor 68 may sense angular displacement in three dimensions and provides motion data indicative of the angular displacement of the motion sensor 68 at distinct instants of time and at an angular resolution that is less than the known angular resolution of the pixels 76 in the focal plane array 64. The motion sensor 68 may be a micromechanical sensor including a gyroscope to sense and provide signals indicative of angular displacement in three dimensions. Optionally, the motion sensor 68 may have a plurality of accelerometers to detect translation (i.e., to determine how far the motion sensor 68 has moved in a particular direction) and/or a magnetic sensor to determine an absolute heading or reference direction. In some embodiments, the motion sensor 68 may not have any mechanism to determine a real-world location of the motion sensor 68. Rather, the motion sensor 68 may be configured to determine relative changes in position of the motion sensor 68, such as angular displacement in three dimensions at distinct instants of time.

The processor 72 may communicate with and receive the motion data from the motion sensor 68, and the image pixel data (e.g., images 74) from the focal plane array 64. The processor 72 may assign at least one set of motion data with each of the images 74, and may then use a plurality of the images 74, as well as the angular displacement of a series of a first one of the image frames relative to a second one of the image frames, to generate an enhanced thermal image (not shown) or video having an image enhancement. In some embodiments, the processor 72 solely uses the data indicative of the angular displacement provided by the motion sensor 68 without using a set of tie points in the images 74, and also without detecting a location of any particular object within the images 74. In these embodiments, the image enhancements may be made without using conventional image processing techniques for geo-referencing, or determining location of an object in three-dimensional space, such as aero-triangulation, stereo photogrammetry, or bundle adjustment. In fact, the location of the focal plane array 64 in three-dimensional space may not be used in the image enhancement techniques described herein. Of course, the camera system 32 may also include a Global Positioning System, or the like, to determine the location of the focal plane array 64 in real-world coordinates for use in interpreting information within the enhanced thermal image (not shown).

In one embodiment, the processor 72 receives the image pixel data generated at distinct instants of time during an image capture period from the focal plane array 64 and motion reading(s) during the image capture period, converts the motion readings into angular displacement of the focal plane array 64, and selecting one or more image processing algorithms to generate at least one image enhancement for the image pixel data based upon the angular displacement of the focal plane array during the image capture period.

The processor 72 may include hardware, such as a central processing unit, an application specific integrated circuit (ASIC), or a field programmable gate array (FPGA), or a combination of hardware and software. Software includes one or more computer executable instructions that when executed by one or more component (e.g., central processing unit) causes the component to perform a specified function. It should be understood that the algorithms described herein are stored on one or more non-transitory memory. Exemplary non-transitory memory includes random access memory, read only memory, flash memory or the like. Such non-transitory memory may be electrically based or optically based. The processor 72 may include only one processor, or multiple processors working together to perform a task. The processor 72 may be located adjacent to the focal plane array 64 and the motion sensor 68, and communicate with the focal plane array 64 and the motion sensor 68 via any suitable mechanism, such as a printed circuit board, for example. Or, the processor 72 may be located remotely from the focal plane array 64 and the motion sensor 68, and receive the image pixel data and the motion data via a network. The network may be a wired network, a wireless network, an optical network, or combinations thereof.

Referring now to FIG. 4, shown therein is a partial diagrammatic view of an exemplary embodiment of the camera system 32 constructed in accordance with the present disclosure. In the embodiment shown in FIG. 4, the focal plane array 64 has a two-dimensional array of pixels 76. The pixels 76 may be implemented in a variety of manners depending upon the wavelengths of light that are intended to be detected. For example, when it is desired for the pixels 76 to sense visible light, the pixels 76 may be incorporated onto an integrated circuit (IC) chip 84. When it is desired for the pixels 76 to sense infrared radiation, the pixels 76 may be implemented as microbolometers integrated onto the IC chip 84. The focal plane array 64 may be adapted to operate without a mechanical shutter, in a global shutter operating mode or a rolling shutter operating mode. In the global shutter operating mode, each pixel 76 is exposed simultaneously at the same instant in time, and may be read simultaneously. In the rolling shutter operating mode, each row of pixels 76 is exposed and read separately. The focal plane array 64 may also have an on-chip row circuitry 88 and column circuitry 92. The row circuitry 88 and the column circuitry 92 may enable one or more various processing and operational tasks such as addressing pixels, decoding signals, amplification of signals, analog-to-digital signal conversion, applying timing, read out and reset signals, and/or the like. The focal plane array 64 may also include an amplifier 96, an analog-to-digital conversion circuit 100 and a line driver circuit 104, which generates a multi-bit (e.g., 8-bit or 10-bit) signal indicative of light incident on each pixel 76 of the focal plane array 64. The output of the line driver 104 may be presented on a set of output pins of an integrated circuit. The focal plane array 64 may also include a timing/control circuit 108 which may include such components as a bias circuit, a clock/timing generation circuit, an oscillator, and/or the like.

The processor 72 may be co-located with, or remote from the focal plane array 64. The processor 72 may include a main processor IC chip 112, a memory array 116, and an actuation module 120. The main processor IC chip 112 may be a multifunctional IC chip having an integrated frame grabber circuit 124 and a central processing unit (CPU) 128. In some embodiments, the focal plane array 64, the motion sensor 68, the processor 72, and the memory array 116 may be integrated into a single component. The actuation module 120 may generate a trigger signal that initiates a capture process in which multiple image frames are captured and stored in the memory array 116 for use in generating the enhanced thermal image (not shown). The actuation module 120 may include an actuator 132, that may be a manually actuated trigger or a software program that receives an instruction to cause the capture of multiple images 74 and motion data for generating the enhanced thermal image (not shown). The camera system 32 further includes at least one optical element 136. The optical element 136 may be any device configured to direct and/or focus the electromagnetic waves onto the focal plane array 64, such as a lens, mirror(s), pin-hole, or combinations thereof.

The memory array 116 may include a non-transitory memory device, such as a RAM, EPROM, or flash memory. The memory array 116 may be in communication with the processor IC chip 112 via a system bus 140.

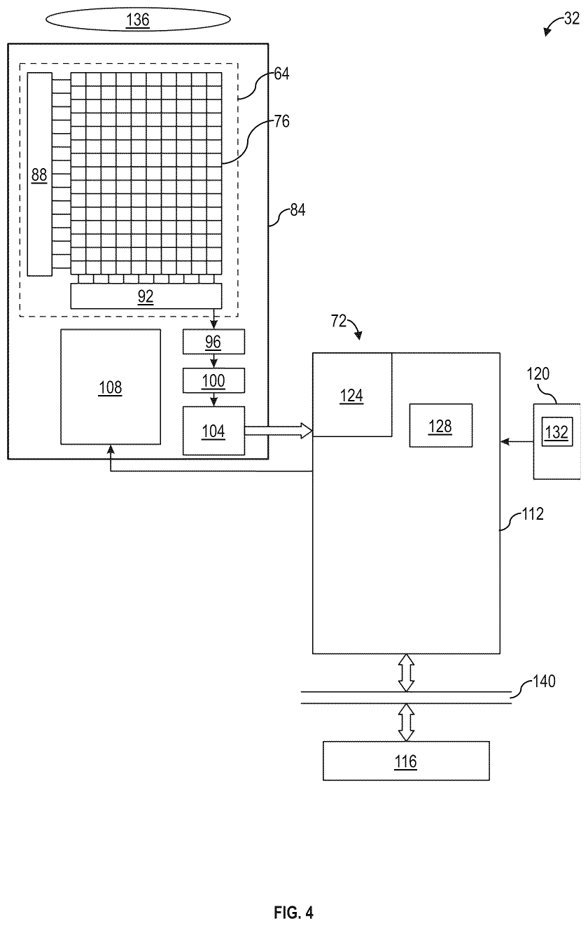

Referring now to FIG. 5, shown therein is an exemplary embodiment of a method 148 of enhancing a thermal image 74a captured by a microbolometer-based infrared image sensor (i.e., the focal plane array 64) of a thermal camera (i.e., the camera system 32) in accordance with the present disclosure. As shown in FIG. 5, the method 148 generally comprises the steps of: receiving a thermal image 74a (shown in FIG. 6A) represented as a first array of numerical pixel values having i pixel rows 168 (shown in FIG. 6A) and j pixel columns 172 (shown in FIG. 6B) (step 152); determining a dynamic range of the thermal image 74a (step 156); converting the thermal image 74a into an upscaled thermal image 74b (shown in FIG. 6B) represented as a second array of numerical pixel values having 2i pixel rows 168 and 2j pixel columns 172 by extrapolating numerical pixel values in the i pixel rows 168 in a vertical direction and in the j pixel columns 172 in a horizontal direction (step 160); and applying a kernel 176 (shown in FIG. 6C) to the numerical pixel values of the second array representing the upscaled thermal image 74b to produce an enhanced thermal image (not shown), the kernel 176 having a strength factor based at least in part on the dynamic range of the thermal image 74a (step 164). In some embodiments, noise of the thermal image 74a or the upscaled thermal image 74b can be analyzed and quantified, and in these embodiments, the strength factor can be based on (as an alternative to or in addition to the dynamic range) on an amount of noise quantified within the thermal image 74a or the upscaled thermal image 74b. The noise can be measured as fixed pattern noise, such as row noise, or column noise, or the noise can be measured as temporal noise instead of fixed pattern noise. It should be understood that a person of ordinary skill in the art understands how to measure and quantify noise including fixed pattern noise and temporal noise using one or more techniques such as signal to noise ratio. Therefore, no further comments regarding how to measure and quantify noise is deemed necessary to teach the skilled artisan how to make and use the presently disclosed inventive concepts.

In some embodiments, determining the dynamic range of the thermal image 74a (step 156) is further defined as determining a span of the thermal image 74a based at least in part on a difference between a highest numerical pixel value of the first array representing the thermal image 74a and a lowest numerical pixel value of the first array representing the thermal image 74a. In other embodiments, determining the dynamic range of the thermal image 74a (step 156) is further defined as determining a span of the thermal image 74a based at least in part on a standard deviation of the numerical pixel values of the first array. In still other embodiments, prior to determining the dynamic range of the thermal image 74a (step 156), the method 148 further comprises removing one or more lowest numerical value and one or more highest numerical value from the first array representing the thermal image 74a. In such embodiments, determining the dynamic range of the thermal image 74a (step 156) is further defined as determining a span of the thermal image 74a based at least in part on a difference between a highest remaining numerical pixel value of the first array representing the thermal image 74a and a lowest remaining numerical pixel value of the first array representing the thermal image 74a.

In some embodiments, the method 148 further comprises calculating the strength factor based on an expression given by:

$$S = maximum ( ( span - lower threshold ) * scaling factor , 0 )$$

wherein lower threshold is a predetermined lower threshold, and scaling factor is a predetermined scaling factor. In some embodiments, the predetermined lower threshold (i.e., lower threshold) is 300 counts. In some embodiments, the predetermined scaling factor (i.e., scaling factor) is 0.002.

In some embodiments, the kernel 176 is a 3×3 kernel, and the method 148 further comprises calculating the kernel 176 based on an expression given by

$$[ \begin{matrix}0 & 0 & 0 \\ 0 & 1 & 0 \\ 0 & 0 & 0\end{matrix} ] + [ \begin{matrix}0 & - 1 & 0 \\ - 1 & 4 & - 1 \\ 0 & - 1 & 0\end{matrix} ] * S .$$

Referring now to FIG. 6A, shown therein is an exemplary embodiment of a thermal image 74a constructed in accordance with the present disclosure. The thermal image 74a has a plurality of pixel rows 168, including a first pixel row 168a shown in FIG. 6A, and a plurality of pixel columns 172, including a first pixel column 172a shown in FIG. 6A. While the thermal image 74a is shown as having four of the pixel rows 168 and four of the pixel columns 172, it should be understood that the thermal image 74a may have more or less than four of the pixel rows 168 and more or less than four of the pixel columns 172.

Referring now to FIG. 6B, shown therein is an exemplary embodiment of an upscaled thermal image 74b constructed in accordance with the present disclosure. As described above, the method 148 may comprise the step of converting the thermal image 74a into an upscaled thermal image 74b represented as a second array of numerical pixel values having ni pixel rows 168 and nj pixel columns 172 where n>1 by extrapolating each of the numerical pixel values in the i pixel rows 168 in a vertical direction and in the j pixel columns 172 in a horizontal direction (step 160). In some embodiments, n can be within a range from 1 to 4. In some embodiments, n=2. In some embodiments, extrapolating each of the numerical pixel values can be accomplished by copying the numerical pixel values, or by interpolating using an algorithm such as splines to calculate the new values to be applied in the horizontal direction and the vertical direction.

As shown in FIG. 6B, the pixel values in each of the pixel rows 168 (e.g., the first pixel row 168a) may be copied in a vertical direction, thereby resulting in a plurality of pixel rows 168 which are each a copy of one of the pixel rows 168 of the thermal image 74a, including a second pixel row 168b which is a copy of the first pixel row 168a. Similarly, the pixel values in each of the pixel columns 172 (e.g., the first pixel column 172a) may be copied in a horizontal direction, thereby resulting in a plurality of pixel columns 172 which are each a copy of one of the pixel columns 172 of the thermal image 74a, including a second pixel column 172b which is a copy of the first pixel column 172a.

While the step of converting the thermal image 74a into the upscaled thermal image 74b represented as a second array of numerical pixel values (step 160) is described herein as involving a copying of the numerical pixel values in each of the pixel rows 168 and each of the pixel columns 172, it should be understood that, in some embodiments, the numerical pixel values in each of the pixel rows 168 and each of the pixel columns 172 may be copied more than once. In such embodiments, the second array of numerical pixel values representing the upscaled thermal image 74b may have xi pixel rows 168 and xj pixel columns 172, where x represents the number of copies of the numerical pixel values in each of the pixel rows 168 and each of the pixel columns 172.

Referring now to FIG. 6C, shown therein is an exemplary embodiment of a kernel 176 constructed in accordance with the present disclosure being applied to the upscaled thermal image 74b shown in FIG. 6B. While the kernel 176 is shown as a 3×3 kernel, it should be understood that the kernel 176 may have more or less than three rows/columns. For each input pixel (i, j) of the upscaled thermal image 74b, the intensity of the output pixel (i, j) of the enhanced thermal image (not shown) after the kernel 176 is applied is given by:

$${I}^{′} ( i , j ) = {\sum }_{m = - 1}^{1} {\sum }_{n = - 1}^{1} I ( i + m , j + n ) * K ( m + 1 , n + 1 )$$

where I(i, j) is the intensity of the pixel (i, j) of the thermal image 74a, I′(i, j) is the intensity of the pixel (i, j) of the enhanced thermal image (not shown), and K (u+1, v+1) is the value of the kernel 176 at position (u+1, v+1). The double summation thus iterates over the 3×3 region around the pixel (i, j) of the upscaled thermal image 74b.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A system, comprising:
a thermal camera comprising one or more thermal image sensor operable to convert infrared radiation into a thermal image, the thermal image having pixels in an array of numerical pixel values having i rows and j columns;
a processor; and
a non-transitory processor-readable medium storing processor-executable instructions that when executed by the processor cause the processor to:
determine a dynamic range of the thermal image; and
apply a kernel to numerical pixel values of the array to produce an enhanced thermal image, the kernel having a strength factor based at least in part on the dynamic range of the thermal image.

2. The system of claim 1, wherein the one or more thermal image sensor includes microbolometers, the microbolometers being operable to detect infrared radiation.

3. The system of claim 1, wherein determining the dynamic range of the thermal image is further defined as determining a span of the thermal image based at least in part on a difference between a highest numerical pixel value of the array representing the thermal image and a lowest numerical pixel value of the array representing the thermal image.

4. The system of claim 1, wherein determining the dynamic range of the thermal image is further defined as determining a span of the thermal image based at least in part on a standard deviation of the numerical pixel values of the array representing the thermal image.

5. The system of claim 1, wherein the processor-executable instructions when executed by the processor further cause the processor to, prior to determining the dynamic range of the thermal image, removing one or more lowest numerical value and one or more highest numerical value from the array representing the thermal image, and determining the dynamic range of the thermal image is further defined as determining a span of the thermal image based at least in part on a difference between a highest remaining numerical pixel value of the array representing the thermal image and a lowest remaining numerical pixel value of the array representing the thermal image.

6. The system of claim 1, wherein the processor-executable instructions when executed by the processor further cause the processor to calculate the strength factor based on an expression given by max((dynamic range−lower threshold)*scaling factor, 0), where lower threshold is a predetermined lower threshold, and scaling factor is a predetermined scaling factor.

7. The system of claim 1, wherein the kernel is a 3×3 kernel.

8. The system of claim 7, wherein the processor-executable instructions when executed by the processor further cause the processor to calculate the kernel based on an expression given by
$$[ \begin{matrix}0 & 0 & 0 \\ 0 & 1 & 0 \\ 0 & 0 & 0\end{matrix} ] + [ \begin{matrix}0 & - 1 & 0 \\ - 1 & 4 & - 1 \\ 0 & - 1 & 0\end{matrix} ] * strength factor .$$

9. A system, comprising:
a thermal camera comprising one or more thermal image sensor operable to convert infrared radiation into a thermal image, the thermal image having pixels in a first array of numerical pixel values having i rows and j columns;
a processor; and
a non-transitory processor-readable medium storing processor-executable instructions that when executed by the processor cause the processor to:
determine a dynamic range of the thermal image;
convert the thermal image into an upscaled thermal image represented as a second array of numerical pixel values having ni rows and nj columns by extrapolating numerical pixel values in the i rows in a vertical direction and in the j columns in a horizontal direction, wherein n is within a range from 1 to 4; and
apply a kernel to numerical pixel values of the second array to produce an enhanced thermal image, the kernel having a strength factor based at least in part on the dynamic range of the thermal image.

10. A non-transitory processor-readable medium storing processor-executable instructions that when executed by a processor cause the processor to:
receive a thermal image represented as an array of numerical pixel values having i rows and j columns;
determine a dynamic range of the thermal image; and
apply a kernel to numerical pixel values of the array to produce an enhanced thermal image, the kernel having a strength factor based at least in part on the dynamic range of the thermal image.

11. The non-transitory processor-readable medium of claim 10, wherein determining the dynamic range of the thermal image is further defined as determining a span of the thermal image based at least in part on a difference between a highest numerical pixel value of the array representing the thermal image and a lowest numerical pixel value of the array representing the thermal image.

12. The non-transitory processor-readable medium of claim 10, wherein determining the dynamic range is further defined as determining a span of the thermal image based at least in part on a standard deviation of the numerical pixel values of the array representing the thermal image.

13. The non-transitory processor-readable medium of claim 10, wherein the processor-executable instructions when executed by the processor further cause the processor to, prior to determining the dynamic range of the thermal image, removing one or more lowest numerical value and one or more highest numerical value from the array representing the thermal image, and determining the dynamic range of the thermal image is further defined as determining a span of the thermal image based at least in part on a difference between a highest remaining numerical pixel value of the array representing the thermal image and a lowest remaining numerical pixel value of the array representing the thermal image.

14. The non-transitory processor-readable medium of claim 10, wherein the processor-executable instructions when executed by the processor further cause the processor to calculate the strength factor based on an expression given by strength factor=max((dynamic range−lower threshold)*scaling factor, 0), where lower threshold is a predetermined lower threshold, and scaling factor is a predetermined scaling factor.

15. The non-transitory processor-readable medium of claim 10, wherein the kernel is a 3×3 kernel, and the processor-executable instructions when executed by the processor further cause the processor to calculate the kernel based on an expression given by
$$[ \begin{matrix}0 & 0 & 0 \\ 0 & 1 & 0 \\ 0 & 0 & 0\end{matrix} ] + [ \begin{matrix}0 & - 1 & 0 \\ - 1 & 4 & - 1 \\ 0 & - 1 & 0\end{matrix} ] * strength factor .$$

16. The non-transitory processor-readable medium of claim 10, wherein the array is a first array, and wherein the processor-executable instructions that when executed by the processor cause the processor to convert the thermal image into an upscaled thermal image represented as a second array of numerical pixel values having ni rows and nj columns by extrapolating numerical pixel values in the i rows in a vertical direction and in the j columns in a horizontal direction, wherein n is within a range from 1 to 4, and wherein applying the kernel is defined further as applying the kernel to numerical pixel values of the second array to produce an enhanced thermal image, the kernel having a strength factor based at least in part on the dynamic range of the thermal image.

17. The non-transitory processor-readable medium of claim 10, wherein the processor-executable instructions that when executed by the processor cause the processor to cause a thermal camera to capture the thermal image.
